(19) United States
(12) Patent Application Publication
(10) Pub. No.: US 2012/0292551 A1
(43) Pub. Date: Nov. 22, 2012

(54) AQUEOUS COMPOSITION AND METHOD FOR FIRE CONTROL

(75) Inventor: Freddy Kai Klaffmo, Arbra (SE)

(73) Assignee: MILJOSLACKNING I ALINGSAS AB, Alingsas (SE)

(21) Appl. No.: 13/388,675

(22) PCT Filed: Aug. 5, 2010
(86) PCT No.: PCT/SE2010/050876

§ 371 Date: Aug. 3, 2012

Related U.S. Application Data
(60) Provisional application No. 61/231,779, filed on Aug. 6, 2009.

(30) Foreign Application Priority Data
Aug. 6, 2009 (SE) 0950581-9

(51) Int. Cl. A62D 1/00; C09K 21/12

(52) U.S. Cl. 252/2; 252/601

(57) ABSTRACT

The present invention discloses a composition and the use of the same in fire control applications. The fire control applications include fire extinguishing and flame proofing of liquids, semisolids and solids. The composition comprises an organic phosphorous containing compound, an oil and a detergent. The organic phosphorous containing compound is a compound of formula (I), or a complex, solvate or hydrate thereof, wherein M is selected from the group consisting of H, NH₄, Na and K, and R is C₁₋₆ alkyl or a substituent according to formula (II).

### TECHNICAL FIELD

The present invention relates to an aqueous composition for use in fire control applications, for fire extinguishing and as flame retardant.

### BACKGROUND

Two general principles for the repression of the harm and seriousness of burning combustible materials include: (i) the lowering of the materials tendency to kindle by treatment with a suitable composition, e.g. impregnation with a flame retardant, and (ii) extinguishing of the fire with a suitable liquid, solid or gaseous composition. Examples of the composition according to (i) include compositions containing e.g. organic phosphorous containing compounds, and according to (ii), e.g. bicarbonate, halogenated hydrocarbon and carbon dioxide containing compositions.

For a generally applicable fire-extinguishing composition, it is desirable that the composition has additional fire retarding properties in accordance with the first (i) general principle above. The reason for this is to be found in the mechanisms by which a fire spreads and re-ignites. A fire spreads by ignition of the material adjacent to the burning material, either by direct contact with the flames or indirectly by the heat radiation. Re-ignition is often caused, as in the case of e.g. re-ignition of e.g. a liquid petroleum fuel or oil, by local heating above the flash point caused by heat radiation or direct contact with a hot object or material. Hence, if the materials tendency to kindle is lowered by the fire-extinguishing composition, the spreading of the fire is inhibited and the extinguishing of the same facilitated. Furthermore, when the flames have been put out, the chances of subsequent re-ignition are diminished in comparison to the case of employment of fire-extinguishing means which are lacking additional fire retarding properties.

Additional desirable properties of a generally applicable fire-extinguishing composition, beside its effectiveness as flame retardant and fire extinguisher, include:
Low toxicity.
Low environmental impact.
Low cost of composing constituents
Easy preparation and handling, e.g. by firefighters.
No smell or a pleasant smell.
High stability enabling long term storage without decomposition and/or physical changes, e.g. precipitation, of the composition.
Suitable physicochemical properties, e.g. viscosity, density, tixotropy and lipophilicity, to allow facile and controlled application by e.g. the spraying through nozzles and/or pumping through fire-hoses.
Suitable physicochemical properties to allow effective fire-extinguishing of burning liquid hydrocarbons.

The most well known and used fire-extinguishing composition, which fulfills many of the above mentioned desired properties, is common water. When used in fire-fighting, water contacts burning objects which results in sufficient cooling such that the burning objects fall below their combustion or ignition temperatures, and new ignition is precluded. In addition, when water contacts hot objects, the water vaporizes to produce steam, which expands and expels the air necessary for combustion.

However, when a fire is extinguished by spraying water on the fire, only a part of the sprayed water is effective because of water loss, such as by run-off or evaporation. In addition, water is not suitable for the fire-fighting of burning liquid hydrocarbons, e.g. gasoline, as the generated steam causes an explosion-like increase and spread of the flames.

In order to improve the properties of water in flame proofing and fire-fighting applications, additives such as fire retarding chemicals, which may retard combustion for at least brief periods even after the water has evaporated, as well as having a direct fire-extinguishing effect, are being developed and are presently in use. Additional additives include, for example, thickening agents and different foam forming agents. Various forms of organic and inorganic phosphorous containing compounds represent commonly used fire retarding chemicals.

EP1065309 A1 describes a composition for fire protection treatment of textile materials consisting of an aqueous solution of carbamide and a complex of the ammonium salt of an amidoalkylphosphonic acid and ammonium chloride. The same or a similar composition can be obtained by dissolution of a commercially available product named Noflan®. In addition, a process for fireproofing treatment of textile materials by employment of this composition is also described. The textile material, which is first allowed to undergo an impregnation with a melamine-type resin and/or silicon-containing compounds in order to achieve e.g. a good fixation of the phosphorous containing flame retarder, is subsequently treated with the composition, before heat treatment at elevated temperature.

One disadvantage of this composition is the multistep procedure utilized for the fireproofing treatment and e.g. the equipment needed for heating the material which is being fireproofed. Furthermore, this composition is not well suited for storage over prolonged time periods due to physical and/or chemical change and decomposition, respectively.

EP1418178 A1 discloses the ammonium salt of nitrilotris(methylene) triphosphonic acid amide, which is useful as a flame retardant of polymeric materials by addition to the polymer at the stage of polymer processing, and may be used for the fireproofing of e.g. textiles by treating the same with the corresponding aqueous formulation.

GB2299094 A discloses an aqueous formulation comprising a polymer in which an organic phosphorous containing compound has been bonded to the same. This formulation may be used for the fire proofing of e.g. textiles. The organic phosphorous containing compounds, acting as starting materials to be bonded to suitable reactive functional groups of the polymer, include dialkyl phosphites, oligomers of vinylphosphonic esters, oxoacids of phosphorus and their corresponding salts, and esters or salts of methylphosphonic acid. The material treated with the aqueous formulation, e.g. a textile, is preferably subsequently treated at an elevated temperature in a drying oven in order to enhance the integrity of the polymer and/or complete the bonding of the organic phosphorous containing compound to the polymer.

A disadvantage, common to all of the above aqueous formulations and compositions (described in EP1065309 A1, EP1418178 A1 and GB2299094 A), include the non-optimal physical chemical properties for the application of the same by e.g. spraying or sprinkling. Furthermore, all of the above documents (EP1065309 A1, EP1418178 A1 and GB2299094 A) fail to mention use of the respective formulation or composition in fire-extinguishing applications.

Hence, an improved aqueous formulation useful for fire fighting, including fire extinguishing and fire proofing, would be advantageous.

### SUMMARY OF THE INVENTION

It is an object of the present invention, to provide a generally applicable fire-extinguishing composition.

It is another object of the present invention, to provide a composition which is effective both as flame retardant and fire extinguisher.

It is another object of the present invention, to provide a composition which is effective for fire fighting of burning organic liquids including, for example, combustion and reaction engine fuels and related hydrocarbons like e.g. gasoline and kerosene.

It is another object of the present invention, to provide a composition which is effective as fire extinguisher and/or flame retardant and which simultaneously exhibits all of the following properties: low toxicity, environmentally friendly, easy preparation and handling, suitable for long term storage and suitable physicochemical properties to allow facile and controlled application.

These and other objects, which will appear from the following description, have now been achieved by a composition according to the present invention which comprises an organic phosphorous containing compound, an oil and a detergent. The organic phosphorous containing compound is a compound of formula (I),

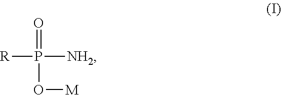

or a complex, solvate or hydrate thereof, wherein M is selected from the group consisting of H, NH₄, Na and K, and R is C₁₋₆ alkyl or a substituent according to formula (II)

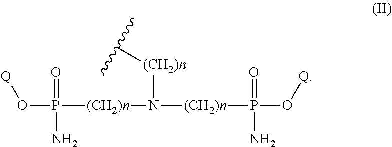

Q of the substituent according to formula (II) is independently selected from the group consisting of H, NH₄, Na and K, and n is an integer number from 1 to 3. The composition according to the present invention may be used in fire control applications.

Further features of the invention and its embodiments are set forth in the appended claims.

### DETAILED DESCRIPTION OF THE EMBODIMENTS

Several embodiments of the present invention will be described in more detail below with reference to the accompanying formulas in order for those skilled in the art to be able to carry out the invention. The invention may, however, be embodied in many different forms and should not be construed as limited to the embodiments set forth herein. Rather, these embodiments are provided so that this disclosure will be thorough and complete, and will fully convey the scope of the invention to those skilled in the art. The embodiments do not limit the invention, but the invention is only limited by the appended patent claims. Furthermore, the terminology used in the detailed description of the particular embodiments illustrated in the accompanying drawings is not intended to be limiting of the invention.

According to one embodiment of the invention, there is provided an aqueous composition comprising: an organic phosphorous containing compound; an oil; a detergent; and optionally at least one additional additive.

According to one embodiment, the organic phosphorous containing compound is a compound of formula (I) and complexes, e.g. the ammonium chloride complex, or solvates or hydrates thereof, or a commercially available product which contains at least one compound represented by formula (I) as a main constituent.

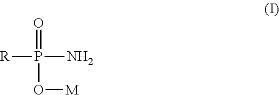

The generic molecular fragments of a compound of formula (I) are represented by the following molecular fragments, in which:

M is selected from the group consisting of H, NH₄, Na and K; and

R is C₁₋₆ alkyl, e.g. methyl, ethyl, n-propyl and i-propyl, or a substituent according to formula (II).

The generic molecular fragments of the substituent of formula (II) are represented by the following molecular fragments, in which:

Q is independently selected from the group consisting of H, NH₄, Na and K; and

“n” is an integer number from 1 to 3, denoting the number of methylene-groups connected to each other to form a linkage between the nitrogen atom and the phosphorous atom.

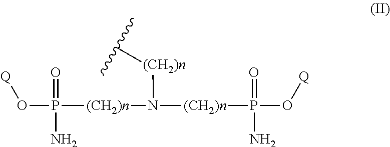

According to one embodiment of the invention, the oil of the composition is selected from the group consisting of a liquid paraffinic oil, a liquid paraffinic oil of petroleum origin, a medicinal liquid paraffin, a mixture of straight and/or branched and/or cyclic alkanes, such as alkanes with 15 to 40 carbon atoms having a melting point or melting range below room temperature.

According to another embodiment of the invention, the oil is baby oil, such as the baby oil “mjukt & skönt” from AB Gunry in Kungsbacka, Sweden.

According to another embodiment of the invention, the oil is massage oil.

According to another embodiment of the invention, the oil is a liquid ester of glycerin or a liquid mixture of such esters.

According to another embodiment of the invention, the oil is an oil of vegetable origin with relatively low toxicity such as coconut oil, corn oil, cottonseed oil, olive oil, palm oil, peanut oil, rapeseed oil, safflower oil, sesame oil, soybean oil, sunflower oil, amaranth oil, apricot oil, apple seed oil, argan oil, artichoke oil, avocado oil, babassu oil, ben oil, borneo tallow nut oil, yangu oil, cocklebur oil, cohune oil, dika oil, false flax oil, flax seed oil, grape seed oil, hemp oil, kapok seed oil, manila oil, meadowfoam seed oil, mustard oil, okra seed oil, papaya seed oil, perilla seed oil, poppyseed oil, prune kernel oil, quinoa oil, ramtil oil, rice bran oil and tea seed oil.

According to another embodiment of the invention, the oil is an oil of vegetable origin such as castor oil, coconut oil, cottonseed oil, palm oil, peanut oil, radish oil, rapeseed oil, rice bran oil, safflower oil, salicornia oil, sunflower oil, tung oil, copaiba, honge oil, jatropha oil, jojoba oil and petroleum nut oil.

According to another embodiment of the invention, the oil is a cooking oil such as, for example, olive oil, sunflower oil, safflower oil, canola oil, soybean oil, peanut oil, sesame oil, corn oil, mustard oil, palm oil, grape seed oil, almond oil, and walnut oil.

According to one embodiment of the invention, the detergent of the composition according to the present invention may comprise at least one surfactant and optionally additional ingredients commonly used in detergents as well known in the art, e.g. pH-buffering compounds, compounds that modify foaming properties, sultaine surfactant hydrotropes, corrosion inhibitors and preservatives, e.g. N-alkylisothiazolinone and/or chlorinated derivatives thereof.

According to one embodiment of the invention, the surfactant of the detergent of the composition of the invention may comprise at least one of the components belonging to the group consisting of anionic-, cationic-, zwitterionic- and nonionic amphiphilic organic compounds.

The anionic surfactant may be, for example, a sulphate, e.g. sodium dodecyl- or lauryl sulphate or ammonium lauryl sulphate; a sulphonate, e.g. perfluorooctanylsulphonate or various alkyl benzene sulphonates; and a carboxylate, e.g perfluorooctanoate, and various fatty acid salts or soaps.

The cationic surfactant may be, for example, a quarternary ammonium salt such as an alkyl trimethylammonium salt, e.g. cetyl trimethylammonium bromide; or a pyridinium salt, e.g. cetylpyridinium chloride.

Zwitterionic surfactants include, for example, CHAPS, betaine derivatives like cocamidopropyl betaine and dodecyl betaine, and cocoyl glycinates.

Examples of nonionic amphiphilic organic compounds include suitably substituted, e.g. alkylated, poly(ethylene oxides), Triton X-100, copolymers of ethylene oxide and propylene oxide, suitably substituted, e.g. alkylated, glucosides such as octyl glucoside and decyl maltoside, long chain alcohols, e.g. cetyl alcohol and oleyl alcohol, fatty acid amides like cocamide, sorbitol derived compounds like esters of sorbitan and PEG-ylated sorbitan.

According to one embodiment of the invention, the detergent of the composition is a commercially available fabric softener.

According to another embodiment of the invention, the detergent of the composition is a commercially available liquid or dry dishwashing detergent.

According to another embodiment of the invention, the detergent of the composition is a commercially available liquid dishwashing detergent, such as YES® or Fairy® from Procter & Gamble.

According to one embodiment of the invention, the organic phosphorous containing compound is commercially available Noflan®, the oil is a commercially available baby oil or a cooking oil, and the detergent is a commercially available liquid dishwashing detergent.

According to one embodiment of the invention, the organic phosphorous containing compound is a compound of formula (I), or the ammonium chloride complex thereof, wherein R is methyl, ethyl, n-propyl or i-propyl, and M is NH₄; the oil is a commercially available baby oil or a cooking oil; and the detergent is a commercially available liquid dishwashing detergent.

It was surprisingly found that the aqueous composition according to the invention constitute an excellent general fire fighting composition with fire extinguishing and fire retarding properties.

With “fire-extinguish” or simply “extinguish” with reference to flames or fire, or the like, is to be understood herein a treatment which puts out the flames of a fire.

With “flame proofing”, “fire proofing”, “flame retardation”, “fire retardation”, or the like, is to be understood herein a treatment which lowers a materials tendency to kindle, such as, for example, impregnation.

Much of the unexpected effectiveness and many the unforeseen advantages of the composition according to the invention are due to the simultaneous presence therein of the organic phosphorous containing compound, the oil, and the detergent.

Without being bound to theory, the inventor believes that the oil and the surfactant of the detergent forms micelles or similar aggregates, with the hydrophilic regions in contact with surrounding water and the inner hydrophobic cavity being occupied with, amongst other possible components, the oil. In this environment, the organic phosphorous containing compound is partitioned between the surrounding water, the oil of the inner cavity of the micelles, and the hydrophobic part of the surfactant of the same micelles. By this molecular distribution, which is an equilibrium process, the organic phosphorous containing compound is evenly dispersed upon administration of the composition. As one of the compartments between which the organic phosphorous containing compound is distributed vanishes (e.g. the water due to evaporation), the remaining compartments helps to keep the organic phosphorous containing compound in solution in microscopic aggregates without precipitation into larger aggregates which are less effectively spread. This molecular distribution furthermore stabilizes the composition from physical changes as well as chemical degradation.

In fire fighting applications the composition may, for example, be used for the extinguishing of fires in water immiscible flammable liquids, e.g. gasoline. In this application, the composition has an advantage that no or less increase of the intensity of the fire due to a steam explosion occurs, which is the case with common water or other water based compositions. In addition, the composition effectively prevents re-ignition of the flammable liquid once the fire has been put out by employment of the same. Most of the, for example, commonly used foam-based fire fighting compositions are not as effective in this regard as the composition according to the invention.

Additional burning flammable liquids which may be extinguished by employment of the present composition include water miscible organic liquids like methanol, ethanol and acetone, and mixtures of these with each other or petroleum products like, for example, gasoline.

Without being bound to theory, the inventor believes that the compositions ability to inhibit ignition or re-ignition of a flammable liquid, which has a temperature near its flash point, is due to the diminished tendency of that liquid, in comparison to the same liquid which has not been treated with the composition, to emit flammable gases.

The composition may also be used for the extinguishing of fires in other combustible materials for which conventional fire fighting means are presently employed including, for example, wood (e.g. forest fires), paper, textile and industrial waste.

One advantage of the composition with regard to fire fighting of burning solid materials, for example wood and tree-based materials, is its excellent flame retarding properties upon direct administration by e.g. spraying The suitable physicochemical properties of the composition, for example its low surface tension, enables a more even spread of the composition on the surface of the solid material and a deeper penetration into the same, in comparison to other flame retarding agents of the prior art.

In one non-limiting fire-fighting application according to one embodiment, the composition may be used when barbequing meat by, for example, spraying small bursts of the composition at regions of the glowing coal where unwanted flames are appearing due to dripping flammable grease from the meat, to effectively extinguish these flames. The low toxicity of the composition is advantageous in this application.

In one non-limiting fire-fighting application according to one embodiment, the composition may be used to pre-treat, by e.g. spraying, materials or objects in order to flame proof these. Such materials and objects include, for example, houses located near a raging fire and trees located near a raging forest-fire. The physicochemical properties of composition, which is making the composition facile to spread in an effective way, is advantageous in this application.

Examples of liquids, of which the flames when burning may be extinguished with the composition of the invention, include water immiscible organic solvents that are liquids at room temperature, organic solvents that are partly soluble in water and liquids at room temperature, combustion- and reaction-engine fuels and related hydrocarbons like e.g. gasoline and kerosene, water miscible organic liquids and solvents like methanol, ethanol and acetone, vegetable oils that are liquids at room temperature like cooking oils used for e.g. deep-flying of food.

Examples of semisolids, such as greases, gums or other at room temperature amorphous materials, of which the flames when burning may be extinguished with the composition of the invention, include fat of animal origin such as bacon-fat, grease of petroleum or synthetic origin such as lubricating grease, rubber such as in car tires, and tars such as e.g. wood-, coal-, shale- and refined tars.

Examples of solids, of which the flames when burning may be extinguished with the composition of the invention, include wood, trees, sawdust, paper, textile, house-refuse and industrial waste.

According to one embodiment, the herein above mentioned liquids, semisolids and solids may be flame proofed by treatment with the composition according to the invention.

The constituents of the composition according to the invention are either commercially available products, available at a low cost, or easily prepared from cheap commercially available chemicals.

The composition according to the invention is a solution or colloid with a homogenous appearance. It is stable in respect of no, or minimal, observation of either of discoloration, precipitation, flocculation, creaming, breaking or coalescence when stored over relevant time-periods, e.g. over several months at room temperature. Thus, it is well suited for storage in e.g. tanks or containers, such as fire-extinguishers, in order to be readily available in case of a fire which needs to be extinguished. Preferably, such containers are made of a material that is not reacting chemically with the composition, for example, a suitable plastic material or stainless steel.

The relative proportions of the constituting ingredients of the composition according to the invention may be varied so that a composition which is optimal for the particular fire fighting or fire retarding application is obtained, as well known to the skilled person. For example, the physical properties, e.g. the viscosity, may be fine-tuned by varying the relative proportions of the constituting ingredients to generate the desired drop-size and/or stream-shape as the composition is discharged through a particular nozzle, or other type of outlet, used in the application of the same.

Furthermore, the selection of the constituting ingredients within the scope of the invention may be chosen such that a composition which is optimal for the particular fire fighting or fire retarding application is obtained, as well known to the skilled person. For example, the combination of a particular oil and detergent may be chosen to optimize the stability of the composition so that no or minimal precipitation, or any other physical change, occurs upon storage of the composition in e.g. reservoirs at sites, like airports or gas stations, where readily available fire fighting capabilities are desired. Another example include the choice of a suitable dyestuff as an additional additive for the fire fighting of e.g. forest fires, whereby treated areas are easily spotted, as known in the art.

According to one embodiment of the invention, there is provided an aqueous composition comprising 1 to 20% by weight of the organic phosphorous containing compound, 0.015 to 3.35% by weight of the oil, and 0.0165 to 4% by weight of the detergent.

According to a preferred embodiment of the invention, there is provided an aqueous composition comprising 4 to 15% by weight of the organic phosphorous containing compound, 0.6 to 2.5% by weight of the oil, and 0.65 to 3% by weight of the detergent.

According to an even more preferred embodiment of the invention, there is provided an aqueous composition comprising 4 to 8% by weight of the organic phosphorous containing compound, 0.6 to 1.35% by weight of the oil, and 0.65 to 1.6% by weight of the detergent.

According to a yet even more preferred embodiment of the invention, there is provided an aqueous composition comprising 6% by weight of the organic phosphorous containing compound, 0.9 to 1% by weight of the oil, and 1 to 1.2% by weight of the detergent.

According to one embodiment of the invention, the organic phosphorous containing compound is commercially available Noflan®.

According to one embodiment of the invention, the organic phosphorous containing compound is the compound of formula (I).

According to one embodiment of the invention, the organic phosphorous containing compound is the compound of formula (I), or the ammonium chloride complex thereof, wherein R is methyl, ethyl, n-propyl or i-propyl, and M is NH₄.

According to one embodiment of the invention, the organic phosphorous compound is a compound of formula (I), wherein R is a substituent according to formula (II), M is NH₄, Q is NH₄, and n is 1.

According to one embodiment of the invention, the oil of the composition of the present invention has relatively low toxicity.

According to one embodiment, the oil may be a mixture of two or more oils selected from one or more of the herein above mentioned possible oils.

According to one embodiment of the invention, the detergent of the composition is practically pH-neutral in the sense that it does not cause the pH of the composition to fall below pH 4, preferably not below pH 6, and to not exceed pH 10, preferably to not exceed pH 8.

According to one embodiment of the invention, an additive of the composition of the present invention is a nitrogen containing compound. Several nitrogen containing compounds are known in the art to act as fire retardants. Hence, such an additive has the advantage of further enhance the fire retarding properties of the composition according to the invention.

According to one embodiment of the invention, the organic phosphorous containing compound is the compound of formula (I), and an additive is a nitrogen containing compound. The proportion of the nitrogen containing compound is in the range of 5 to 25% by weight relative the compound of formula (I), preferably 8 to 12%.

According to one embodiment of the invention, an additive of the composition of the present invention is urea.

According to one embodiment of the invention, the nitrogen containing additive of the composition is a fire retarding compound as known in the art, for example, a 1,3,5-triazine derivative, e.g. melamine; a heptazine derivative, e.g. melem and melon; and a cyanuric acid derivative, e.g. tris-2-hydroxyethyl isocyanurate.

According to one embodiment of the invention, additional additives of the composition of the present invention comprise, for example, suitable magnesium-, aluminum-, zink-, and calcium salts, known in the art to have a fire retarding effect, including, for example, magnesium hydroxide, aluminum hydroxide, zinc hydroxystannate, calcium cyanamide, zinc cyanamide, boric acid, zinc borate and other boric acid salts. One or several of these additives may further enhance the fire protecting properties of the composition according to the invention.

According to one embodiment of the invention, additional additives of the composition of the present invention comprise, for example, heat or light stabilizers, lubricants, film-forming agents, plasticizers, colorants, pigments, dyestuffs, hydrophilizing agents, hydrophobizing agents and thickeners. Such additives may further enhance the stability, the fire fighting capability, the ease of spotting where the composition has been applied, and improve the physicochemical properties of the composition to be more optimal for the particular application. The selection of a particular one of these additives for the enhancement or improvement of a given property, is known to the one skilled in the art.

According to one embodiment of the invention, an additional additive of the composition of the present invention may be a foam forming agent, as well known in the art, which results in the generation of, for example, an aqueous film forming foam, an alcohol-resistant aqueous film forming foam, and a film formed from fluoroproteins.

According to one embodiment of the invention, an additional additive of the composition of the present invention may be an anti-freeze agent such as ethylene- or propylene glycol. The composition may then be stored at temperatures below freezing point, for example outdoors, without solidification.

According to one embodiment of the invention, an additional additive of the composition of the present invention may be a thixotropy enhancing agent as known in the art, i.e. an additive which will increase the tendency of the composition to a attain a stable gel like form at rest but to become more fluid-like when agitated. Such a property is beneficial in certain applications related to fire extinguishing or flame proofing of e.g. solid materials as it decreases the compositions tendency to run off the same.

According to one embodiment of the invention, the composition of the invention may be used as the main active fire fighting component in an active fire protection device. Such an active fire protection device may be a hand held or cart-mounted fire extinguisher used to extinguish or control small fires. A suitable propellant, for example nitrogen, air, or carbon dioxide, may be used.

According to one embodiment, the composition may be used for fire extinguishing or fire retardation of fires of fire classes A, B and F, according to the European classification system.

According to one embodiment, the composition may be used for fire extinguishing or fire retardation of fires of fire classes A, B and K, according to the American classification system.

According to one embodiment, the composition may be used for fire control of a liquid including, for example, water immiscible organic solvents that are liquids at room temperature, organic solvents that are partly soluble in water and liquids at room temperature, combustion- and reaction-engine fuels and related hydrocarbons like e.g. gasoline and kerosene, water miscible organic liquids and solvents like methanol, ethanol and acetone, and vegetable oils that are liquids at room temperature like cooking oils used for e.g. deep-frying of food.

According to one embodiment, the composition may be used for fire control of a solid including, for example, wood, trees, sawdust, paper, textile, house-refuse and industrial waste.

According to one embodiment, the composition may be used for fire control of a semisolid including, for example, fat of animal origin such as bacon-fat, grease of petroleum or synthetic origin such as lubricating grease, rubber such as in car tires, and tars such as e.g. wood-, coal-, shale- and refined tars.

One embodiment of the invention is illustrated by the following example describing the preparation of an exemplary composition according to the invention: To a borosilicate glass container was added commercially available Noflan® (600 g), commercially available baby oil of the brand “mjukt & skönt” from AB Gunry in Kungsbacka in Sweden (100 g), and the commercially available liquid dishwashing detergent YES® from Procter & Gamble (120 g). Hot water (10.0 liter), with a temperature being kept within the range of 50 to 65° C., was thereafter added under mechanical stirring. The mixture was thereafter mechanically stirred while being allowed to reach room temperature to yield a composition according to the invention.

In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1. An aqueous composition comprising
an organic phosphorous containing compound, an oil and a detergent,
said organic phosphorous containing compound being a compound of formula (I), 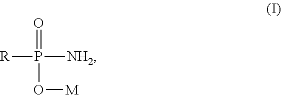
or a complex, solvate or hydrate thereof, wherein:
M is selected from the group consisting of H, NH₄, Na and K;
R is C₁₋₆ alkyl or a substituent according to formula (II), 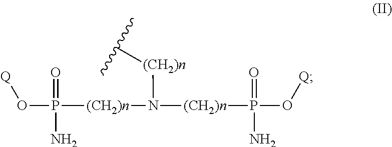
Q is independently selected from the group consisting of H, NH₄, Na and K;
n is an integer number from 1 to 3; and
said composition comprises 1 to 20% by weight of said organic phosphorous containing compound, 0.015 to 3.35% by weight of said oil, and 0.0165 to 4% by weight of said detergent.

2. A composition according to claim 1, wherein M is NH₄ and R is C₁₋₃ alkyl.

3. A composition according to claim 1, wherein said organic phosphorous containing compound comprises a complex with ammonium chloride.

4. A composition according to claim 1, wherein said oil is selected from the group consisting of a liquid paraffinic oil, a liquid paraffinic oil of petroleum origin, a medicinal liquid paraffin, a mixture of straight or branched or cyclic alkanes with 15 to 40 carbon atoms, a baby oil, a massage oil, a liquid ester of glycerin or a liquid mixture of said liquid esters, a cooking oil, and an oil of vegetable origin.

5. A composition according to claim 1, wherein said detergent comprise at least one amphiphilic organic compound selected from the group consisting of anionic-, cationic-, zwitterionic- and nonionic compounds.

6. A composition according to claim 1, further comprising at least one additive selected from the group consisting of a nitrogen containing compound, a fire retarding magnesium-, aluminum-, zink-, or calcium salt, a heat or light stabilizer, a lubricant, a film-forming agent, a foam forming agent, an anti-freeze agent, a thixotropy enhancing agent, a plasticizer, a dyestuff, a hydrophilizing agent, a hydrophobizing agent, and a thickener.

7. Use of a composition according to claim 1 in fire control application.

8. Use according to claim 7, wherein said fire control application comprises fire extinguishing.

9. Use of a composition in fire control application, wherein
said fire control application comprises flame proofing; and
said composition comprises an organic phosphorous containing compound, an oil and a detergent,
said organic phosphorous containing compound comprises a compound of formula (I), 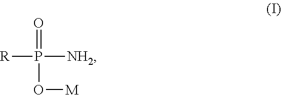
or a complex, solvate or hydrate thereof,
wherein:
M is selected from the group consisting of H, NH₄, Na and K;
R is C₁₋₆ alkyl or a substituent according to formula (II), 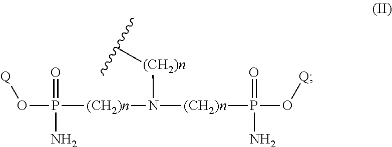
Q is independently selected from the group consisting of H, NH₄, Na and K; and
n is an integer number from 1 to 3.

10. Use according to claim 9, wherein said fire control application comprises fire control of a liquid.

11. Use according to claim 9, wherein said fire control application comprises fire control of a solid.

12. Use according to claim 9, wherein said fire control application comprises fire control of a semisolid.

13. Use according claim 9, wherein said composition is used for fire control of fires of fire classes A, B and F, according to the European classification system, or for fire control of fires of fire classes A, B and K, according to the American classification system.

14. Use according to claim 9, wherein said composition comprises an active component in an active fire protection device.

15. Use according to claim 14, wherein said device comprises a hand held or cart-mounted fire extinguisher.

16. Use according to claim 9, wherein said fire control application comprises fire extinguishing.

17. Use according to claim 9, wherein said composition comprises 1 to 20% by weight of said organic phosphorous containing compound, 0.015 to 3.35% by weight of said oil, and 0.0165 to 4% by weight of said detergent.
